(19) United States
(12) Patent Application Publication
(10) Pub. No.: US 2008/0075982 A1
(43) Pub. Date: Mar. 27, 2008

(54) SUBSTRATE FOR MAGNETIC RECORDING MEDIUM, METHOD OF MANUFACTURE OF SAME, AND MAGNETIC RECORDING MEDIUM

(75) Inventor: Takashi SHIMADA, Matsumoto City (JP)

Correspondence Address: ROSSI, KIMMS & McDOWELL LLP., P.O. BOX 826, ASHBURN, VA, 20146-0826, US

(73) Assignee: FUJI ELECTRIC DEVICE TECHNOLOGY CO., LTD., Tokyo (JP)

(21) Appl. No.: 11/855,098

(22) Filed: Sep. 13, 2007

(30) Foreign Application Priority Data
Sep. 26, 2006 (JP) 2006-261133

(51) Int. Cl. G11B 5/706; B24B 7/00

(52) U.S. Cl. 428/848; 451/177

(57) ABSTRACT

A substrate for a magnetic recording medium is disclosed which enables formation of a magnetic recording medium for which both the electromagnetic transducing characteristics and the recording head flying characteristics can be maintained at high levels. In a substrate for a magnetic recording medium comprising a disc-shaped nonmagnetic body, and having on the surface thereof a plurality of texture marks the circumferential direction component and the radial direction component of which change continuously, there are at least four types of modes of this continuous change, and cross angles are formed by each of the texture marks themselves obtained by the modes of change, so that overall at least four types of cross angles are formed on the substrate.

### CROSS REFERENCE TO RELATED APPLICATIONS

This application claims priority from Japanese application Serial No. 2006-261133, filed on Sep. 26, 2006, the contents of which are incorporated herein in their entirety.

### BACKGROUND OF THE INVENTION

A. Field of the Invention

This invention relates to a substrate for a magnetic recording medium, that can be mounted in various magnetic recording devices such as an external storage device of a computer. More specifically, this invention relates to a substrate for a magnetic recording medium enabling formation of a magnetic recording medium for which both electromagnetic transducing characteristics and recording head flying characteristics can be maintained at high levels. This invention also relates to a method of manufacture of such a substrate and to a magnetic recording medium using such a substrate.

B. Description of the Related Art

Representative examples of magnetic recording media include glass magnetic recording media which use glass substrates, and aluminum magnetic recording media using aluminum substrates. These magnetic recording media are all formed by layering a magnetic layer, protective layer, and so forth on a specific substrate. Thus, magnetic recording media require a substrate, and normally a texture pattern with depression and protrusion shapes is formed on the substrate surface.

In Japanese Patent Laid-open No. 4-349218, a substrate for magnetic recording media is disclosed in which a texture pattern comprises a circular texture component comprising concentric circles and an intersecting texture component which intersects with the circular texture component, as an example of texture pattern formation.

Texture patterns are generally formed by fixing the substrate to a spindle and rotating the substrate, and then, while dripping an abrasive slurry comprising diamond or other abrasive particles onto the substrate surface, using a rubber roller or other means to press an abrasive cloth, comprising a woven cloth or a nonwoven cloth, against the substrate.

In Japanese Patent Laid-open No. 4-349218, as one example of texture pattern formation, an example is disclosed in which are performed a process of forming an intersecting component (non-circumferential direction texture component) by an oscillation operation of causing a texturing tape to undergo reciprocating motion in a radial direction, and a process of forming a circular texture component (circumferential direction texture component) by fixed oscillation operation of a texturing tape. As disclosed in Japanese Patent Laid-open No. 4-349218, a texture pattern can be obtained by means which performs, as separate processes, a process of formation of the non-circumferential direction texture component and a process of formation of the circumferential direction texture component; but the texture pattern can also be obtained by means of rotating the spindle while performing oscillation, to perform these processes in one action.

In all of the above formation means, by appropriately controlling the parameters of the oscillation amplitude and the oscillation velocity or the substrate rotation velocity, the desired formation means is obtained. In the prior art, upon executing control to keep constant the different control parameters such as oscillation amplitude using such formation means, a texture mark comprising fixed tracks on the substrate is formed. This texture mark has numerous points of intersection due to its nature, and as a result, numerous intersecting angles are formed. Normally, among such numerous intersecting angles, the largest angles are called cross angles.

In recent years, with increases in the recording density of magnetic recording media, the area occupied on the recording media by one bit, as the smallest unit of data written to magnetic recording media, has become progressively smaller. One means of accommodating such higher recording densities is to improve the electromagnetic transducing characteristics when performing reading and writing using a recording head. In order to improve electromagnetic transducing characteristics, it is effective to cause the easy axis of magnetization in the magnetic layer to be in the circumferential direction, which is the recording direction, and to increase the ratio of the circumferential-direction remanent magnetization to the radial-direction remanent magnetization (hereafter also called the “Mrt-OR”). And another means of accommodating higher recording densities is to reduce the spacing loss between the magnetic head and the magnetic recording media through reduction of the flying height of the recording head; but a reduced flying height necessitates improved flying characteristics (flying stability). Reduction of the contact area with the recording head is effective for improving flying characteristics.

In this way, when focusing on electromagnetic transducing characteristics, it is essential that the direction of extension of texture marks be oriented insofar as possible in the circumferential direction, which is the recording direction, that is, that the above-described cross angles be made small. However, when focusing on the flying characteristics of the recording head, it is important that the cross-angles be increased in order to reduce the contact area with the flying head. Hence there is a need to develop a substrate for magnetic recording media which enables formation of magnetic recording media for which both of these characteristics can be maintained at a high level with respect to the substrate cross angles.

Hence an object of this invention is to provide a substrate for magnetic recording media enabling formation of magnetic recording media which achieves high levels of both electromagnetic transducing characteristics and recording head flying characteristics. A further object of this invention is to provide a method of manufacture of such a substrate, and magnetic recording media using this substrate. The present invention is directed to overcoming or at least reducing the effects of one or more of the problems set forth above.

### SUMMARY OF THE INVENTION

This invention relates to a substrate for a magnetic recording medium, comprising a disc-shaped nonmagnetic body, and having on the surface thereof a plurality of texture marks, the circumferential direction component and radial direction component of which change continuously, such that there exist at least four types of modes of continuous change, and cross angles are formed by each of the texture marks themselves obtained by the modes of change, so that overall at least four types of cross angles are formed on the substrate. A substrate for a magnetic recording medium of this invention can be applied to formation of a magnetic recording medium which can be mounted in various magnetic recording devices. It is desirable that in a substrate for a magnetic recording medium of this invention, among the above at least four types of cross angles, the largest cross angle is 1° or greater.

This invention relates to a method of manufacture of a substrate for a magnetic recording medium in which a substrate is rotated with an abrasive cloth pressed against the substrate surface while causing the abrasive cloth to undergo reciprocating motion in a radial direction of the substrate, to form a plurality of texture marks the circumferential direction component and radial direction component of which change continuously. During rotation, at least one of the rotation velocity of the substrate and the velocity of reciprocating motion of the abrasive cloth is changed to at least four different velocities, and cross angles are formed by each of the texture marks themselves obtained by the respective (rotation) velocities, so that overall at least four types of cross angles are formed on the substrate.

This invention further comprises a magnetic recording medium formed by forming at least a magnetic layer on top of the above-described substrate for a magnetic recording medium.

A substrate for a magnetic recording medium of this invention can be applied to formation of a magnetic recording medium which achieves high levels of both electromagnetic transducing characteristics and recording head flying characteristics. For this reason, a magnetic recording medium using this substrate can fully accommodate the demands of recent years for higher recording densities.

### BRIEF DESCRIPTION OF THE DRAWINGS

The foregoing advantages and features of the invention will become apparent upon reference to the following detailed description and the accompanying drawings, of which:

FIG. 1 is a plan view showing substrate 10 for magnetic recording media of this invention. FIG. 1A is an overall view, and FIG. 1B is an enlarged view of a texture pattern in region 12 of FIG. 1A;

FIG. 2 is a schematic cross-sectional view along line A-A′ in FIG. 1B;

FIGS. 3A and 3B are plan views of a substrate for magnetic recording media, showing examples of the tracks of texture marks when the oscillation velocity is held constant;

FIG. 4 is a plan view of a substrate for magnetic recording media on which the tracks of FIGS. 3A and 3B are superposed to form two types of texture marks;

FIG. 5 shows graphs when cross angles are of one type. FIG. 5A is a graph showing the relation between electromagnetic transducing characteristics and cross angles, and FIG. 5B is a graph showing the relation between flying characteristics and cross angles;

FIG. 6A is a side view of device 20 to manufacture substrates for magnetic recording media of this invention, and FIG. 6B is a cross-sectional view along line B-B′ in FIG. 6A;

FIG. 7 is a cross-sectional view showing the magnetic recording media 40 of this invention; and

FIG. 8 shows graphs for cases in which the number of cross angles is changed. FIG. 8A is a graph showing the relation between electromagnetic transducing characteristics and cross angles, and FIG. 8B is a graph showing the relation between flying characteristics and cross angles.

### DETAILED DESCRIPTION OF SPECIFIC EMBODIMENTS

Below, preferred embodiments of the invention are explained referring to the drawings. The following examples are merely illustrative, and appropriate design modifications can be made by a practitioner of the art within the range of normal creative ability.

### Substrate for Magnetic Recording Media

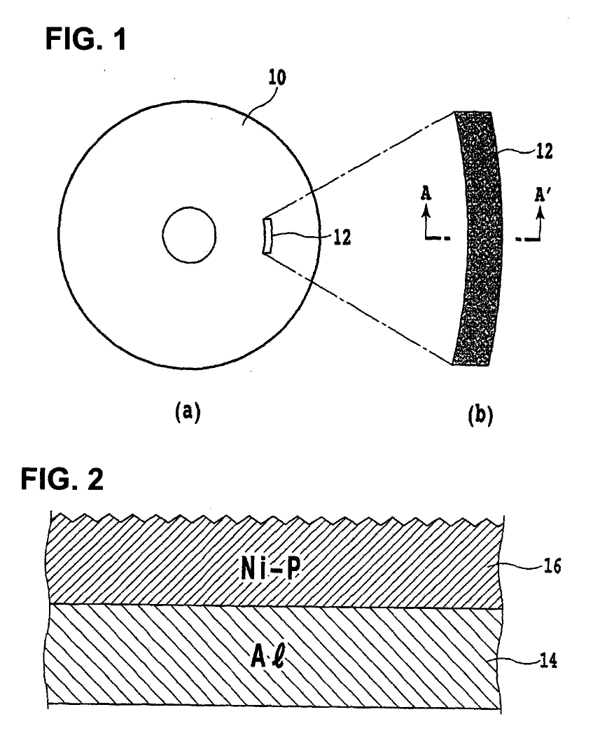

FIG. 1 is a plan view showing substrate 10 for magnetic recording media of this invention. FIG. 1A is an overall view of the substrate, and FIG. 1B is an enlarged view of the texture pattern in region 12 in FIG. 1A. FIG. 2 is a schematic cross-sectional view along line A-A′ in FIG. 1B.

The substrate for magnetic recording media shown in FIG. 1 and FIG. 2 is disc-shaped, and similarly to conventional substrates for magnetic recording media, Ni—P plated film 16 is formed on the surface of aluminum base 14. As shown in FIG. 1B, on this substrate are formed four types of texture marks, the circumferential direction component and radial direction component of which change continuously. When glass is used as the substrate material, four types of texture marks, the circumferential direction component and radial direction component of which change continuously, are formed on the glass surface.

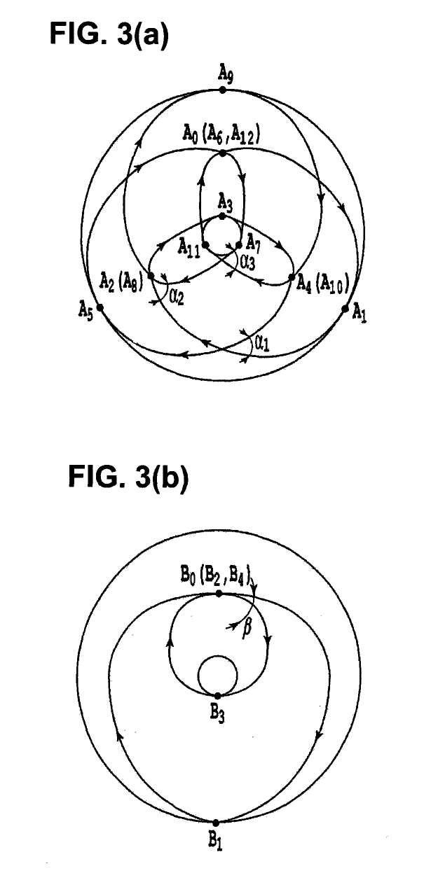

Details of the texture marks are as follows. In this invention, a texture mark is an element comprised by a texture pattern which presents the overall pattern of protrusions and depressions formed on a substrate for magnetic recording media, and is a groove-shaped mark, the tracks of which change continuously in the circumferential direction and in the radial direction. FIG. 3A is a plan view of a substrate showing the tracks of texture marks extending continuously from point A₀ to point A₁₂, and is an example in which, while rotating the substrate four times, reciprocating motion is performed three times in the radial direction to form the texture marks. On the other hand, FIG. 3B is a plan view of a substrate showing the track of texture marks extending continuously from point B₀ to point B₄, and is an example in which, while rotating the substrate two times, reciprocating motion is performed once in the radial direction to form the texture marks. These examples are examples in which the degree of change is constant.

Each of the tracks in FIGS. 3A and 3B is an example of a texture mark for which, as explained above, the circumferential direction component and the radial direction component change continuously to a constant degree. In a substrate for magnetic recording media of this invention, there are formed at least four types of texture marks (as in FIG. 1B) of arbitrary shape, such as shown in FIGS. 3A and 3B. However, one condition imposed is that, in each of the texture marks, intersection points are formed by the mark itself as shown in FIGS. 3A and 3B, and that intersection angles are formed as a result.

As explained above, “cross angle” means an angle made by such intersections. When a plurality of cross angles occur due to a single texture mark, cross angle is used to mean the largest angle among these angles of intersection. For example, in the example shown in FIG. 3A, there exist three types of intersection angles, which are denoted as α₁, α₂, and α₃; in this case, the “cross angle” is α₃. On the other hand, in the example shown in FIG. 3B, there is only one kind of intersection angle, which is denoted as β, and so the “cross angle” is β. In this way, in a substrate for magnetic recording media of this invention, there exist at least four types of cross angles such as α₃ and β.

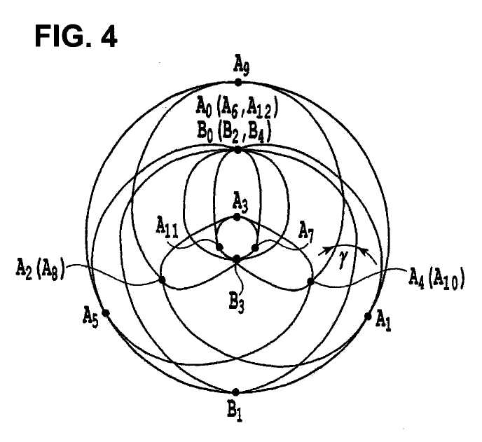

FIG. 4 is an example of two types of texture mark, formed with the tracks in FIGS. 3A and 3B superimposed; thus when a plurality of texture marks are formed, intersection angles appear, as for example denoted by the symbol γ in FIG. 4, at points of intersection occurring between different types of texture marks as well. However, in this invention, the intersection angles at intersection points occurring between different types of texture marks are smaller than cross angles, which are the largest intersection angles occurring due to each of the texture marks themselves, and so such intersection angles are removed from consideration, and only cross angles, which are the largest intersection angles occurring due to each texture mark itself in each mode of change (FIGS. 3A and 3B), are considered.

The reason for the limitation that “at least four types of cross angles exist,” which is a particular characteristic of this invention will now be explained. As described above, in the prior art attention has been focused on improvement of electromagnetic transducing properties and reduction of flying heights for recording heads in response to demands for higher recording densities for magnetic recording media; but there has been the contradiction that, whereas cross angles must be reduced to improve electromagnetic transducing characteristic, cross angles must be increased to lower the flying height of a recording head.

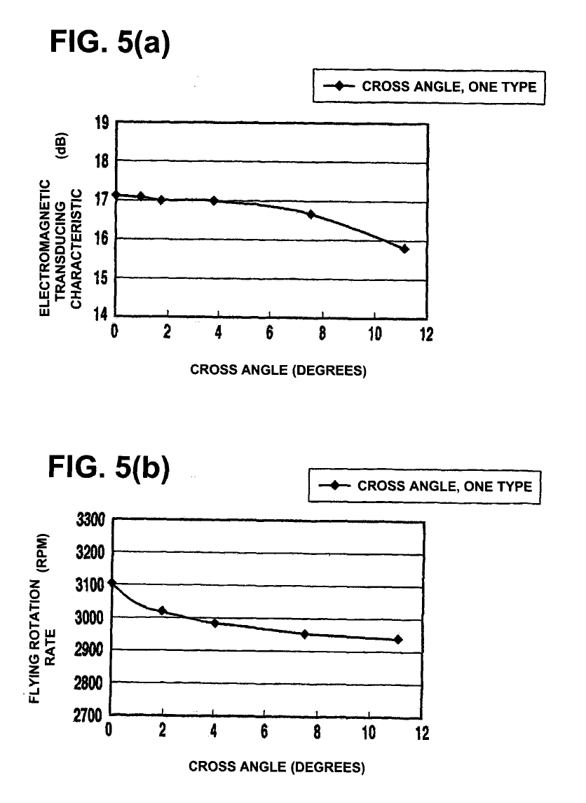

That is, when there is only one mode of continuous change of the circumferential direction component and the radial direction component of texture marks on the substrate, or in other words when there is one type of cross angle, if the cross angle is gradually increased from 0°, then the electromagnetic transducing characteristics gradually decline as shown in FIGS. 5A and 5B. However, because the recording head flies even at low rotation rates, flying characteristics are improved.

Hence the inventor judged that these two elements, which are “improvement of electromagnetic transducing characteristic” and “improvement of recording head flying characteristic” cannot both be maintained at a high level through control of cross angles alone, and so conducted earnest studies which included other elements as well, in order to attain high levels for both the above characteristics.

As a result, it was discovered that if the number of types of texture marks formed on the substrate for magnetic recording media is changed, as described above, and four or more types are used, then both of the above characteristics can be maintained at high levels.

This result was obtained without being constrained by theory in particular, and at the present time the basis thereof is unclear, but the facts which have been ascertained are as follows. That is, in order to maintain at high levels both improvement of electromagnetic transducing characteristics and stabilization of the recording head flying, the inventor focused on the surface roughness (Ra) of the substrate, the range of cross angles due to texture marks formed on the substrate, and the types of cross angles, as parameters. As a result, it was ascertained that, with respect to the surface roughness (Ra) of the substrate, it is preferable that smaller values are preferable in order to make contact of the recording head with the substrate more difficult in glide height tests, and that a smaller value is also preferable to lower the flying height of the recording head. Specifically, it is preferable that the surface roughness Ra be 0.5 nm or less.

As explained above, it was ascertained that with respect to the range of cross angles, it is preferable that the range be small in order to increase Mrt-OR so as to improve the electromagnetic transducing characteristics, and it is preferable that the range be large in order to reduce the contact area with the recording head when stabilizing the recording head flight. Further, with respect to cross angle types, it was ascertained that in order to achieve both a higher Mrt-OR in order to improve the electromagnetic transducing characteristics and also a smaller contact area with the recording head in order to stabilize the recording head flight, a certain number of types are necessary in order to combine texture marks required by various characteristics so as to attain a balance.

Hence on the assumption that the surface roughness (Ra) is made a comparatively small value in order to satisfy the requirement of the above range, detailed studies were conducted on the range and types of cross angles enabling high levels of both electromagnetic transducing characteristic improvement and recording head flight stabilization, and it was ascertained in particular that when texture marks having four or more types of cross angles are formed on the substrate, both of the above characteristics can be achieved.

Further, it was ascertained that with the above conditions satisfied, that is, with the existence of four or more types of cross angle, when the range of cross angles was such that the largest cross angles were 1° or greater, there was a large contribution to improve flying stability, and for this reason both characteristics could be maintained at still higher levels. When the largest cross angles were less than 1°, there was no decline in the electromagnetic transducing characteristics, but no improvement was seen in the flying characteristics.

The substrates for magnetic recording media of this invention were obtained through considerations such as those described above.

### Method of Manufacture of Magnetic Recording Media

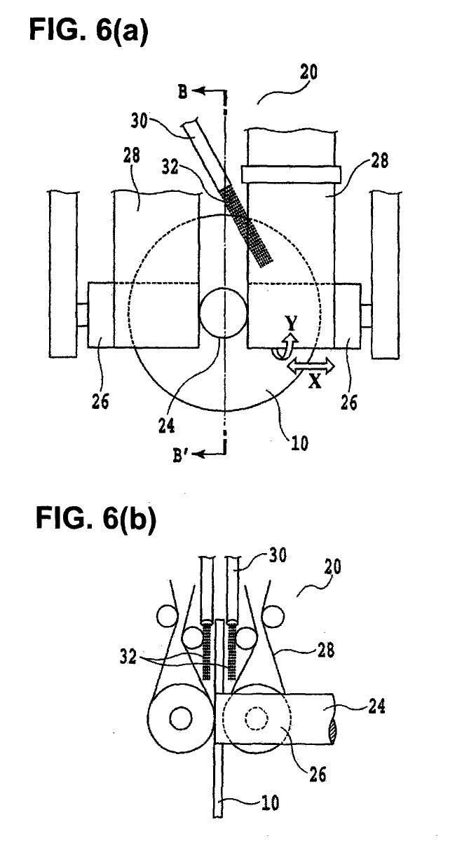

FIG. 6A is a side view showing device 20 used to manufacture magnetic recording media of this invention, and FIG. 6B is a cross-sectional view along line B-B′ in FIG. 6A. As is seen in the figure, substrate 10 for magnetic recording media is mounted on rotating spindle 24, and rubber rollers 26 are positioned on both surfaces of substrate 10 so as to enclose substrate 10. Abrasive cloth (texture tape) 28, comprising woven cloth or nonwoven cloth, is wound about rubber rollers 26, and tape 28 is pressed continuously against the surface of substrate 10.

When forming the texture marks, while releasing polishing liquid 32 comprising a diamond abrasive from nozzle 30, rotating spindle 24 is rotated. Rubber rollers 26 are made to undergo reciprocating motion in the radial direction X of substrate 10 to realize an oscillation operation.

When using the device shown in FIG. 6 to manufacture a substrate for magnetic recording media of this invention, with texturing tape 28 in contact with the surface of substrate 10, the tape is driven in the radial direction X while rotating substrate 10. In the method of manufacture of this invention, at this time at least one of the velocity of driving of tape 28 in the radial direction X and the rotation velocity of substrate 10 is changed among four or more types, and as a result the number of times the tape is driven in the radial direction X during one substrate revolution is changed among four or more different values. Such changes in mode can of course be performed in consecutive processes, or can be performed in separate processes. The pressing force when texturing tape 28 is in contact with substrate 10 must be determined by balancing the amount of machining through texturing, the surface roughness after machining, and similar, but a value in the range 0.5 kgf/cm² and 4 kgf/cm² is preferable. By this means, the four or more types of texture patterns described above can be formed.

In formation of the above texture pattern, when for example the driving velocity in the radial direction X of texturing tape 28 is fixed at a constant speed (at for example 2.5 Hz) with an amplitude of 2 mm, by varying the rotation velocity of substrate 10 among four types between 50 rpm and 1000 rpm (for example, 100 rpm, 160 rpm, 450 rpm, and 600 rpm), magnetic recording media can be formed which enables the desired high levels for both the electromagnetic transducing characteristics and for the recording head flying height characteristics.

Further, in the above formation, when for example the rotation velocity of substrate 10 is fixed at a constant speed (for example 300 rpm), by setting the amplitude in the radial direction X of texturing tape 28 at 2 mm, and varying the driving velocity among four types between 0 Hz and 15 Hz (for example, 0 Hz, 1.1 Hz, 4.7 Hz, and 7.1 Hz), magnetic recording media can be formed which enables the desired high levels for both the electromagnetic transducing characteristics and for the recording head flying height characteristics.

### Magnetic Recording Media

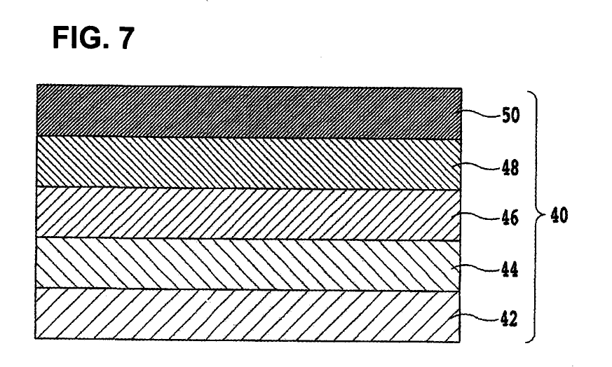

FIG. 7 is a cross-sectional view showing magnetic recording media 40 of this invention. The magnetic recording media shown in the figure comprises, in order on substrate 42, underlayer 44, magnetic recording layer 46, protective layer 48, and liquid lubricant layer 50.

A texture pattern is formed on substrate 42 that comprises at least four types of texture marks, as in the invention described above; no particular limitations are placed on the material. For example, an aluminum alloy, reinforced glass, crystallized glass, ceramic, silicon, polycarbonate, a polymer resin, or other material may be used. On the surfaces of this material, a nonmagnetic metal film comprising an Ni—P film may be formed by electroless plating, or else the glass substrate itself can be used. As the substrate, a disc of any size among 0.85 inch, 1.0 inch, 1.89 inches, 2.5 inches, 3.5 inches, or 5 inches, such as are widely used in this technical field, can be used.

No limitations in particular are placed on underlayer 44, and any composition commonly used in this technical field can be employed. Specifically, a composition comprising at least one among Cr, Cr—W, Cr—V, Cr—Mo, Cr—Si, Ni—Al, Co—Cr, Mo, W, and Pt, can be used. Deposition of the underlayer onto the substrate can be performed by sputtering, plating, or another widely-known method to form a film of the above nonmagnetic materials.

When substrate 42 is a glass substrate, in order to improve the orientation (Mrt-OR) of magnetic recording layer 46, it is preferable that sputtering or another method be used to deposit a seed layer onto the glass substrate (below underlayer 44). As the material of this seed layer, an alloy of Ni, P, Ta, W, Co, Ru, Al, or similar may be used.

Magnetic recording layer 46 comprises a ferromagnetic metal which can be used as a recording layer; specifically, a magnetic material is used having as a component CoCrTaPt, CoCrTaPt—Cr₂O₃, CoCrTaPt—SiO₂, CoCrTaPt—ZrO₂, CoCrTaPt—TiO₂, CoCrTaPt—Al₂O₃, or similar; the recording layer is formed by deposition onto the underlayer using a sputtering method or other film deposition method. A plurality of magnetic recording layers also may be used, to form a recording layer with a multilayer structure. The above-described underlayer is not indispensable. When no underlayer is present, the magnetic recording layer may be deposited directly onto the substrate by sputtering or another method.

Protective layer 48 functions to protect the magnetic recording layer from shocks due to the magnetic head, and to protect the magnetic recording layer from contact with corrosive materials in the outer environment. The protective layer can be formed as a thin film comprising SiO₂ or carbon, but in order to increase the film density and enhance wear resistance, it is preferable that the protective layer be a thin film of carbon in particular. Examples of a carbon film include amorphous carbon with hydrogen added and amorphous carbon with nitrogen added. As the method of carbon film formation, a CVD method (for example, ion beam CVD using ethylene gas), or a sputtering method (for example, DC magnetron sputtering using a graphite target and an argon+nitrogen gas) can be employed.

Liquid lubricant layer 50 is formed by application of a solution, comprising a liquid lubricant diluted by a solvent, onto the protective layer by a dipping method or similar. Liquid lubricants which can be used in this invention include perfluoropolyether and other fluoride liquid lubricants. For example, Fomblin-Z-DOL, AM3001, and Z-Tetraol (all product names), produced by Solvay, and other lubricants normally used with magnetic recording media can be employed. The solvent used to dilute such liquid lubricants need only be miscible with the lubricant and able to form a uniform solution; otherwise no limitations in particular are imposed. For example HFE7200 (product name, manufactured by Sumitomo 3M), Vertrel (product name, manufactured by DuPont-Mitsui Fluorochemicals), and other fluorcarbon solvents may be used.

The magnetic recording media of this invention, obtained as described above, are formed with four or more types of cross angles on the substrate, so that both electromagnetic transducing characteristics and recording head flying characteristics can be maintained at high levels.

### EXAMPLES

Below, the invention is explained in further detail using examples, to verify the advantageous results of the invention.

### Example 1

An amorphous glass substrate was prepared, with the surface roughness adjusted to 0.2 nm by polishing. This substrate was mounted on the device shown in FIG. 6, and a nonwoven cloth comprising polyester and urethane was pressed against the substrate surfaces with a pressing pressure of 1 kgf/cm² via a pressing member with a rubber hardness of 60°; while feeding the nonwoven cloth at a velocity of 20 mm/minute, oscillation was performed with an amplitude of 2 mm, the substrate was rotated at 300 rpm, and polishing was performed for 20 seconds. At this time, a slurry comprising diamond particles of average particle diameter 0.1 μm was dripped onto the substrate.

Here, the oscillation velocity was changed every five seconds (between 0 Hz, 1.1 Hz, 4.7 Hz, and 7.1 Hz) during the 20-second treatment time of the oscillation operation. That is, a substrate for magnetic recording media was fabricated on which there existed four types of texture marks, the circumferential direction component and radial direction component of which changed continuously. Here the cross angles of the four types of texture marks were 0°, 1.73°, 7.51°, and 11.6°.

Then, the substrate thus obtained was cleaned, and a sputtering device was used to deposit a seed layer, an underlayer, a magnetic layer, and a carbon protective layer, after which a liquid lubricant was applied, to complete manufacture of the magnetic recording media.

For this magnetic recording media, the signal-to-noise ratio (SNR) was measured as an index of the electromagnetic transducing characteristics, and the media rotation rate when recording head flight occurs was measured as an index of flying stability. The SNR is the ratio of the output from the magnetic head (the signal) when reading signals written at a certain frequency to the output with the signals erased (the noise); the recording head flight rotation rate is determined by rotating the magnetic recording media at a rotation rate sufficient for magnetic head flight, then loading the magnetic head, and gradually lowering the rotation rate, and measuring the rotation rate at which the magnetic head crashes (no longer flies). The flying state of the magnetic head is judged based on the signal from an AE sensor or similar mounted on the magnetic head or on the arm on which the magnetic head is mounted (in the state of magnetic head flight, there is no output from the sensor, but when the magnetic head crashes, the vibration causes output from the sensor).

### Example 2

Other than modifying the oscillation velocity at approximately 3.3 second intervals (between 0 Hz, 0.52 Hz, 1.1 Hz, 2.35 Hz, 4.7 Hz, and 7.1 Hz) over a machining time of 20 seconds in the oscillation operation, the same method as in Example 1 was used to manufacture a substrate for magnetic recording media. By this means, a substrate for magnetic recording media was obtained on which there existed six types of texture marks, the circumferential direction component and radial direction component of which changed continuously. Here, the cross angles for the six types of texture mark were 0°, 0.83°, 1.73°, 3.75°, 7.51°, and 11.6°. This substrate was used to manufacture magnetic recording media using the same method as in Example 1, and the SNR and recording head flight rotation rate were measured.

### Comparative Example 1

Other than using a single oscillation velocity (0 Hz) over the entire 20 seconds of machining time in the oscillation operation, the same method as in Example 1 was used to manufacture a substrate for magnetic recording media. By this means, a substrate for magnetic recording media was obtained on which there existed one type of texture mark, the circumferential direction component and radial direction component of which changed continuously. Here, the cross angle for the one type of texture mark was 0°. This substrate was used to manufacture magnetic recording media using the same method as in Example 1, and the SNR and recording head flight rotation rate were measured.

### Comparative Example 2

Other than using a single oscillation velocity (7.1 Hz) over the entire 20 seconds of machining time in the oscillation operation, the same method as in Example 1 was used to manufacture a substrate for magnetic recording media. By this means, a substrate for magnetic recording media was obtained on which there existed one type of texture mark, the circumferential direction component and radial direction component of which changed continuously. Here, the cross angle for the one type of texture mark was 11.6°. This substrate was used to manufacture magnetic recording media using the same method as in Example 1, and the SNR and recording head flight rotation rate were measured.

### Comparative Example 3

Other than changing the oscillation velocity approximately every 10 seconds (0 Hz and 7.1 Hz) over the 20 seconds of machining time in the oscillation operation, the same method as in Example 1 was used to manufacture a substrate for magnetic recording media. By this means, a substrate for magnetic recording media was obtained on which there existed two types of texture marks, the circumferential direction component and radial direction component of which changed continuously. Here, the cross angles for the two types of texture marks were 0° and 11.6°. This substrate was used to manufacture magnetic recording media using the same method as in Example 1, and the SNR and recording head flight rotation rate were measured.

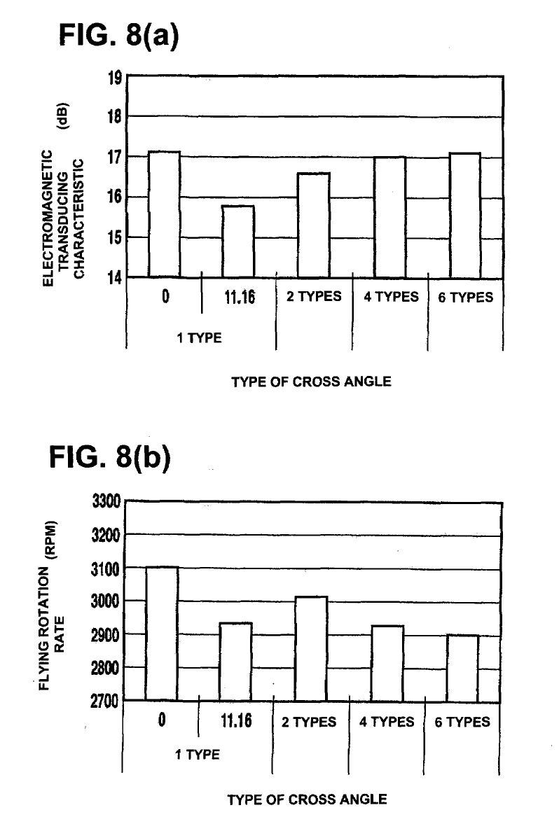

FIG. 8 shows the measured results for the SNR and recording head flying rotation rate for the above Examples 1 and 2 and Comparative Examples 1 through 3. It is seen that for Examples 1 and 2, which are within the scope of the invention (cases in which there exist at least four types of cross angle), the electromagnetic transducing characteristics are satisfactory, and a low flying height is achieved with stability. Hence, in the cases of these examples, high recording densities are satisfactorily achieved.

In contrast, in the cases of each of the comparison examples which deviate from the scope of the invention (with fewer than four types of cross angle), at least one among the electromagnetic transducing characteristic and the flying characteristic is inferior, and high levels for both are not achieved. Specifically, in Comparative Example 1 (with one cross angle at 0°), although the electromagnetic transducing characteristic is superior, the flying characteristic is inferior. In Comparative Example 2 (one cross angle type, at 11.6°), the flying characteristic is superior, but the electromagnetic transducing characteristic is inferior. And in Comparative Example 3 (two cross angle types, at 0° and 11.6°), both the electromagnetic transducing characteristic and the flying characteristic are inferior.

### INDUSTRIAL APPLICABILITY

In this invention, by forming at least four types of cross angles on a substrate for magnetic recording media, magnetic recording media can be formed which attains high levels for both electromagnetic transducing characteristics and for recording head flying characteristics. Hence this invention holds promise for application to the formation of magnetic recording media, from which higher recording densities have been in demand in recent years.

Thus, a substrate for magnetic recording medium, method of manufacture of same, and magnetic recording medium has been described according to the present invention. Many modifications and variations may be made to the techniques and structures described and illustrated herein without departing from the spirit and scope of the invention. Accordingly, it should be understood that the substrates and methods described herein are illustrative only and are not limiting upon the scope of the invention.

What is claimed is:

1. A substrate for a magnetic recording medium, comprising a disc-shaped nonmagnetic body, and having on the surface thereof a plurality of texture marks having a circumferential direction component and a radial direction component, wherein the circumferential direction component and the radial direction component change continuously and there exist at least four different cross angles of the texture marks on the substrate.

2. The substrate for a magnetic recording medium according to claim 1, wherein among the at least four different cross angles, the largest cross angle is 1° or greater.

3. The substrate for a magnetic recording medium according to claim 1, wherein there are at least four variations in the circumferential direction component and/or the radial direction component to produce the at least four different cross angles.

4. A method of manufacture of a substrate for a magnetic recording medium, comprising:
rotating a substrate with an abrasive cloth pressed against the substrate surface while causing the abrasive cloth to undergo reciprocating motion in a radial direction of the substrate to produce a plurality of texture marks having a circumferential direction component and radial direction component, and
varying the circumferential direction component and radial direction component by changing the rotation velocity of the substrate to at least four different velocities, thereby producing at least four different cross angles of the texture marks formed on the substrate.

5. A method of manufacture of a substrate for a magnetic recording medium, comprising:
rotating a substrate with an abrasive cloth pressed against the substrate surface while causing the abrasive cloth to undergo reciprocating motion in a radial direction of the substrate to produce a plurality of texture marks having a circumferential direction component and radial direction component, and
varying the circumferential direction component and radial direction component by changing the frequency of reciprocating motion of the abrasive cloth on the substrate to at least four different frequencies, thereby producing at least four different cross angles of the texture marks formed on the substrate.

6. The method of manufacture of a substrate for a magnetic recording medium according to claim 4, wherein, among the at least four different cross angles, the largest cross angle is 1° or greater.

7. The method of manufacture of a substrate for a magnetic recording medium according to claim 5, wherein, among the at least four different cross angles, the largest cross angle is 1° or greater.

8. A magnetic recording medium, in which at least a magnetic layer is formed on the substrate for a magnetic recording medium according to claim 1.

9. A magnetic recording medium, in which at least a magnetic layer is formed on the substrate for a magnetic recording medium according to claim 2.
